(19) United States
(12) Patent Application Publication
(10) Pub. No.: US 2016/0156782 A1
(43) Pub. Date: Jun. 2, 2016

(54) Outgoing Media Message Management

(71) Applicant: Kirusa, Inc., New Providence, NJ (US)

(72) Inventors: Inderpal Singh Mumick, Berkely Heights, NJ (US); Surinder Singh Anand, Highland, NJ (US)

(73) Assignee: Kirusa, Inc.

(21) Appl. No.: 14/558,701

(22) Filed: Dec. 2, 2014

(51) Int. Cl. H04M 3/533; H04M 3/53; H04W 4/14

(52) U.S. Cl. CPC H04M 3/53333; H04W 4/14; H04M 3/5307; H04M 3/5322

(57) ABSTRACT

A method for managing outgoing media messages (OMMs) employs a message management system (MMS). A first network component receives and routs a call attempt from a calling party to a second network component for establishing a communications link between the calling party and a called party. The second network component redirects the call attempt unanswered by the called party to the MMS on occurrence of an event, for example, the called party being busy, being unreachable, etc. The MMS obtains the OMM recorded by the calling party, provides access to the recorded OMM to the calling party via multiple access modes, and manages actions such as viewing, editing, withdrawing, forwarding, etc., performed on the recorded OMM. On receiving a withdrawal indication from a sender device, the MMS manages a withdrawal action on the recorded OMM by deleting the recorded OMM from the sender device and a recipient device.

### BACKGROUND

As mobile networks have evolved, text based communication and visual based communication have become an integral part of the telecommunication domain. Mobile networks provide various data services, for example, a short message service (SMS), a multimedia messaging service (MMS), a voicemail service, and other data services to send and receive text and other information between the mobile networks and mobile devices.

There are many voice calling systems where a voice call made by a calling party cannot be completed with a called party answering the voice call. Such unanswered voice calls are also referred to as missed calls or incomplete calls. Many of these missed calls remain incomplete, with the calling party having no option to complete the voice call. Some call complete solutions offer the calling party and the called party different methods for completing voice calls. These call complete solutions comprise, for example, voice short message service (SMS) solutions, voicemail solutions, missed call solutions, etc. The voice SMS solutions and the voicemail solutions allow the calling party to record and send a voice message to the called party. The missed call solutions send a missed call alert SMS message to the called party with the hope that the called party will make a new voice call to the calling party. In a mobile communication environment, voicemail is a service that enables mobile subscribers to receive short voice messages from the calling party when the called party is unable to answer the voice call.

Conventionally, a voicemail service is typically offered as a recipient side or a called party side service, where the called party can receive and listen to a voicemail message recorded by the calling party. Mobile applications allow the called party to delete, save, forward, reply, etc., to a voicemail received from the calling party, after listening to the voicemail. In a typical voicemail communication, the calling party would have called the called party and would have been offered an option to record a voicemail message when the called party was unable to answer the voice call, for example, due to the called party being busy, the called party device being switched off, the called party device being in an out of coverage area, the called party not answering the call, etc. The calling party records a voicemail for the called party and the role of the calling party ends when the voicemail message is recorded and sent to the called party. However, there are times when the calling party may not be paying full attention while leaving a voicemail and as a result there are misstatements or errors in the voicemail that was sent. The calling party may therefore wish to edit the voicemail that was sent or the calling party may want to withdraw the voicemail that was sent. Furthermore, even when the calling party has not made any misstatements in the voicemail that was sent, the calling party may wish to browse through the voicemail, listen to the voicemail, or forward or share the voicemail with other recipients or parties. Conventional voicemail services do not allow the calling party to perform actions on outgoing voicemail messages and lack the ability to manage the outgoing voicemail messages which would enhance the calling party's overall communication experience.

Hence, there is a long felt but unresolved need for a method and a computer implemented system that provide options to the calling party and the called party for managing outgoing voicemail messages, incoming voicemail messages, and other media messages.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The method and the computer implemented system disclosed herein address the above stated need for providing options to a calling party and a called party for managing outgoing voicemail messages, incoming voicemail messages, and other media messages. The method and the computer implemented system disclosed herein employ a message management system comprising at least one processor configured to execute computer program instructions for managing outgoing media messages.

A first network component, for example, an originating switch, receives a call attempt made by a calling party to contact a called party. The first network component is associated with the calling party. The first network component routes the received call attempt to a second network component, for example, a terminating switch, for establishing a communications link between the calling party and the called party. The second network component is associated with the called party. The second network component redirects the call attempt unanswered by the called party to the message management system on occurrence of one or more of multiple events. The media message management system receives the unanswered call attempt made by the calling party to the called party and redirected from the second network component. The message management system obtains an outgoing media message recorded by the calling party to complete the unanswered call attempt. The message management system provides access to the recorded outgoing media message to the calling party via multiple access modes over a network, for example, a data network. The message management system manages one or more of multiple actions performed on the recorded outgoing media messages.

In one or more embodiments, related systems include but are not limited to circuitry and/or programming for effecting the methods referenced herein; the circuitry and/or programming can be any combination of hardware, software, and/or firmware configured to effect the herein-referenced methods depending upon the design choices of a system designer. Also, various structural elements may be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing carries over to the description of that method step or component shown by that same numeral in any subsequent drawing herein.

FIG. 1 illustrates a method for managing outgoing media messages.

FIG. 2A exemplarily illustrates a computer implemented system for managing outgoing media messages.

FIG. 2B exemplarily illustrates an implementation of a message management system for managing outgoing media messages.

FIG. 3 exemplarily illustrates the architecture of a computer system employed by the message management system for managing outgoing media messages.

### DETAILED DESCRIPTION OF THE INVENTION

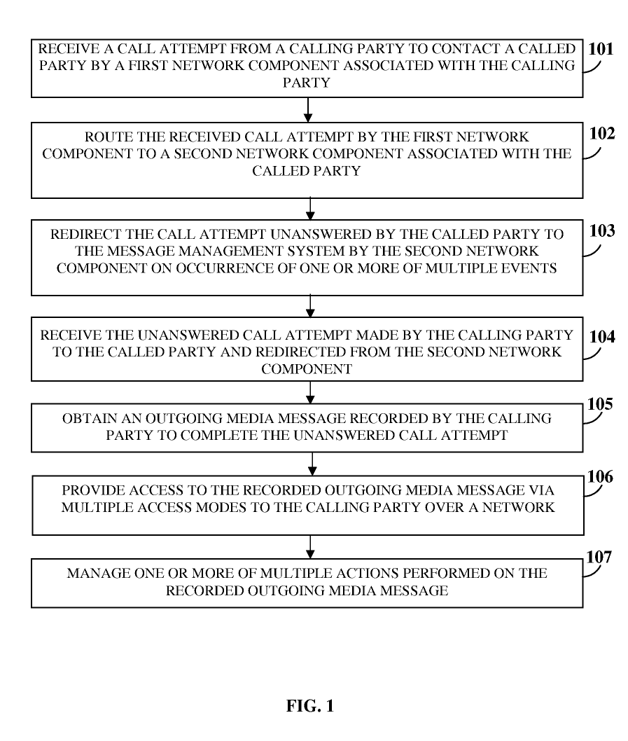

FIG. 1 illustrates a method for managing outgoing media messages. As used herein, “media messages” refer to messages that can be recorded on a calling party's communication device herein referred to as a “calling party device” or a called party's communication device herein referred to as a “called party device”. The calling party device and the called party device can be, for example, mobile computers, cellular phones, mobile phones, smart phones, portable computing devices, tablet computing devices, network enabled computing devices, personal digital assistants, laptops, touch centric devices, audio recorders, video recorders, interactive network enabled communication devices, etc., or any other mobile device configured for communication. An outgoing media message is a message that a user or the calling party has recorded and sent to another user or the called party who is a recipient of a call. The outgoing media message is, for example, a voicemail message, an audio message, a video message, an audiovisual message, a multimedia message, a text message, etc., or any combination thereof. Also, as used herein, “calling party” refers to a user or a sender who originates a call or attempts to place a call to a called party to communicate with the called party. Also, as used herein, “called party” refers to a user who is a recipient or an intended recipient of a call made by the calling party.

The method disclosed herein employs a message management system comprising at least one processor configured to execute computer program instructions for managing outgoing media messages. In an embodiment, the message management system is configured, for example, as a downloadable software application executable by at least one processor on a calling party device and a called party device over a network, a web based platform, a networked system, etc., or any combination thereof. For example, the message management system can be a software application that can be downloaded and can reside on the calling party device or on a web based system hosted on a server in a network, or any combination thereof. The message management system can therefore be an application that resides in the network, or an application that runs on the calling party device, or any combination thereof. A first network component, for example, an originating switch or an originating mobile switching center (MSC), receives 101 a call attempt from a calling party to contact a called party. The first network component is associated with the calling party. The first network component routes 102 the received call attempt to a second network component, for example, a terminating switch or a terminating mobile switching center (MSC), for establishing a communications link between the calling party and the called party. The second network component is associated with the called party. The second network component is either the same as the first network component or one of multiple network components excluding the first network component. As used herein, “first network component” and “second network component” each refer, for example, to a mobile switching center (MSC), a base station subsystem (BSS), a radio access network (RAN), a telephone exchange, a telephone switch, etc., serving the calling party and the called party respectively. The first network component and the second network component, for example, originating and terminating mobile switching centers verify the authenticity of the calling party and the called party respectively, and allocate a voice frequency channel in order to establish the communications link between the calling party device and the called party device.

The second network component redirects 103 the call attempt unanswered by the called party to the message management system on occurrence of one or more of multiple events. As used herein, “unanswered call attempt” refers to a call attempt made by a calling party to a called party, which is not received or answered by the called party due to an occurrence of an event. The event occurs during a call attempt or during the establishment of a communications link between a calling party device and a called party device, but before the called party answers the call attempt. The events comprise, for example, the called party being busy, the called party being in an out of coverage area, the called party being unreachable, the called party device being switched off, network congestion, the call attempt not being answered by the called party, etc. The message management system receives 104 the unanswered call attempt made by the calling party to the called party and redirected from the second network component.

In an embodiment, the message management system transmits an early media notification in one or more of multiple media modes to the calling party for a predefined time period. As used herein, “early media notification” refers to an indication media, for example, textual media, image media, audio media, video media, audiovisual media, multimodal media, etc., or any combination thereof, that is transmitted to a calling party device during the process of setting up a call, before completion of the call, that is, before a called party answers the call. The media modes of the early media notification comprise, for example, a text mode, an image mode, an audio mode, a video mode, an audiovisual mode, a multimedia mode, etc., or any combination thereof. The predefined time period is, for example, a timeout period during which the early media notification is played to the calling party, and the calling party is not billed for listening to the early media notification. For example, an early media notification informs the calling party about the called party device being switched off and requests the calling party to record a voice message after a beep. The time period starting from the beginning of the early media notification till the beep sound is the predefined time period. The voice message is recorded in a time period that begins after the beep is played or after the predefined time period ends. The calling party is billed as per voice rates for the time period equal to the length of the voice message recorded.

The early media notification comprises, for example, a prerecorded message or a ring back tone. As used herein, “prerecorded message” refers to a set of messages prerecorded in an audio format, a video format, or any multimedia format and played to a calling party, for example, by a switching telephone network or a switching center while the calling party is waiting to be connected to the called party. The prerecorded message is, for example, a message informing the calling party regarding status of the called party such as “the called party is busy with another call”, “the called party device is in an out of coverage area”, “the called party device is switched off”, etc. Also, as used herein, “ring back tone” refers to a sound, an audio signal, an audio indication, or a tone played to a calling party, for example, by a switching telephone network or a switching center while the calling party is waiting to be connected to the called party. The calling party hears the ring back tone until the called party answers the call. In an embodiment, the early media notification provides one or more options to the calling party to record an outgoing media message to complete the unanswered call attempt.

The calling party records an outgoing media message on the calling party device to complete the unanswered call attempt and transmits the recorded outgoing media message to the called party via the message management system. The message management system obtains 105 the recorded outgoing media message. In an embodiment, the message management system records the outgoing media message spoken by the calling party. In an embodiment, the message management system stores the recorded outgoing media message in one or more databases. In another embodiment, one or more external message systems record the outgoing media message spoken by the calling party. In another embodiment, one or more external message systems store the recorded outgoing media message acquired from the calling party device. In this embodiment, the message management system communicates with one or more external message systems for fetching or obtaining the recorded outgoing media message from the external message systems.

The message management system provides 106 access to the recorded outgoing media message via multiple access modes to the calling party over a network. The network is a telephone network and/or a data network that connects exchanges, switches, etc. The network is, for example, a wired telephony network, a wireless network, a voice call network, a signaling system number 7 (SS7) network, an internet protocol data network, other data networks, etc. As used herein, “access modes” refer to modes in which a calling party can, for example, access, listen, view, modify, etc., the recorded outgoing media message. The access modes comprise access, for example, via a client application provided on the calling party device, a browser application accessible via the network, an access code such as a number, an alphanumeric code, a symbol, etc., for retrieving the recorded outgoing media message, a voice call made to an interactive voice response (IVR) system to browse and listen to the recorded outgoing media message, a link for retrieving the recorded outgoing media message, etc. For example, a calling party can access a recorded outgoing media message by entering a number or a short code through the calling party device to identify a recorded outgoing media message. In another example, the calling party can access a recorded outgoing media message by making a voice call to a number through the calling party device to browse and listen to the recorded outgoing media message. The client application that provides access to the recorded outgoing media messages is downloadable on the calling party device via the network.

In an embodiment, the message management system disclosed herein transmits a message notification comprising a message retrieval code or a message retrieval link, to the calling party device for retrieving the recorded outgoing media message from the message management system. If the calling party device lacks data network connectivity to access the recorded outgoing media message from the message management system via a client application or a browser application, then the message management system sends a retrieval code, for example, via a short message service (SMS) to the calling party device. The retrieval code comprises, for example, a number that can be dialed from the calling party device to access the recorded outgoing media message, or a retrieval link such as a web link that can be saved and accessed later by the calling party device once the calling party device obtains data network connectivity.

The message management system manages 107 one or more of multiple actions performed on the recorded outgoing media message. The message management system allows the calling party to perform one or more actions on the recorded outgoing media messages. The actions performed on the recorded outgoing media message comprise, for example, viewing the recorded outgoing media message, listening to the recorded outgoing media message, viewing an envelope of the recorded outgoing media message that provides details about the recorded outgoing media message such as date of a call, time of a call, a duration of the recorded outgoing media message, calling party details, called party details, a priority of the recorded outgoing media message, etc., listening to the envelope of the recorded outgoing media message, editing the recorded outgoing media message, deleting the recorded outgoing media message, withdrawing the recorded outgoing media message, marking a priority for the recorded outgoing media message, forwarding the recorded outgoing media message to one or more subsequent parties, sharing the recorded outgoing media message on one or more social networking platforms, etc. In an embodiment, the calling party can also send another media message to the called party via the message management system. The social networking platforms are, for example, micro-blogging and presence applications comprising, for example, Twitter® of Twitter, Inc., Plurk, tmblr.® of Tumblr, Inc., Jaiku® of Google, Inc.; social networking applications such as Bebo® of Bebo, Inc., Facebook® of Facebook, Inc., Twitter® of Twitter, Inc., Linkedin® of Linkedin Corporation, MySpace® of MySpace Inc., Orkut® of Google, Inc., Hi5® of Hi5 Networks, Inc., Ning® of Ning, Inc., etc. As used herein, “subsequent parties” refer to subsequent users or recipients who receive a recorded outgoing media message forwarded by the calling party and/or the called party via a network. In an embodiment, the message management system schedules one or more of the actions performed on the recorded outgoing media message. For example, the message management system schedules forwarding of the recorded outgoing media message to one or more subsequent parties or sharing of the recorded outgoing media message on one or more social networking platforms based on time schedules defined by the calling party.

In an embodiment, the message management system communicates with one or more external message systems that store the recorded outgoing media message for managing the actions performed on the recorded outgoing media message. For example, the message management system integrates with an external message system such as a third party voicemail system to obtain the recorded outgoing media message. In another embodiment, the message management system interfaces with an external message system such as a third party voicemail system to retrieve the recorded outgoing media messages and make them available to the calling party for access and other actions. In an embodiment, the message management system executes entire functions for managing the recorded outgoing media messages. In another embodiment, the message management system is configured to implement voicemail services.

In an embodiment, the message management system manages a withdrawal action performed on the recorded outgoing media message, on receiving a withdrawal indication from a sender of the recorded outgoing media message. As used herein, “sender” refers to a user who sends a recorded outgoing media message to a called party and/or to one or more subsequent parties. The sender is, for example, the calling party who sends a recorded outgoing media message to a called party; or the called party who forwards the recorded outgoing media message to one or more subsequent parties; or one or more subsequent parties who forward the recorded outgoing media message to another one or more subsequent parties. In this embodiment, the message management system deletes the recorded outgoing media message from a sender device of the sender of the recorded outgoing media message and a recipient device of a recipient of the recorded outgoing media message. As used herein, “recipient” refers to a user who receives a recorded outgoing media message from one or more of a calling party, a called party, and one or more subsequent parties. The recipient is, for example, the called party and/or one or more subsequent parties. The sender device and the recipient device are, for example, mobile computers, cellular phones, mobile phones, smart phones, tablet computing devices, personal digital assistants, laptops, etc., or any other mobile device configured for communication.

The message management system allows a sender, who has sent a recorded outgoing media message, to withdraw the recorded outgoing media message from one or more of the recipients of the recorded outgoing media message. In an embodiment, the withdrawal of the recorded outgoing media message can be considered, for example, as a global delete. That is, the recorded outgoing media message is deleted from the sender device of a sender who is withdrawing the recorded outgoing media message, and also from the recipient devices of all the recipients of the recorded outgoing media message. In case of a typical voicemail, the calling party sends the recorded outgoing voicemail message to the called party who is a single recipient. However, if the original recipient, that is, the called party had forwarded the recorded outgoing media message to other users, hereinafter referred to as “subsequent parties”, the message management system deletes the withdrawn recorded outgoing media message from the recipient devices of all the subsequent parties. The message management system enables only a sender that sends a recorded outgoing media message to withdraw the recorded outgoing media message from the recipient devices of the called party and/or the subsequent parties.

Only a sender device can send a withdrawal indication to the message management system. A client application on the sender device communicates the withdrawal indication to the message management system. The message management system receives the withdrawal indication from the client application on the sender device via the network. Once the message management system receives the withdrawal indication from the sender device for withdrawing the recorded outgoing media message, the message management system deletes the recorded outgoing media message from the sender device and each recipient device, and the recorded outgoing media message is no longer available to the sender device and the recipient devices. In an embodiment, the message management system notifies a client application on the recipient device of the recipient who received the recorded outgoing media message to delete the recorded outgoing media message from the recipient device.

After the message management system receives a withdrawal indication from the sender device for withdrawing the recorded outgoing media message from the recipient devices, the message management system marks the recorded outgoing media message as withdrawn in the sender device, while still retaining the recorded outgoing media message in the sender device. The message management system sends a signal to the client application on each of the recipient devices to delete the recorded outgoing media message from each recipient device. In an embodiment, the message management system transmits a notification to each recipient device to indicate the deletion of the recorded outgoing media message from the recipient devices. After the recorded outgoing media message has been deleted from the recipient devices, the client application on each recipient device transmits a notification to the message management system to indicate confirmation of the deletion of the recorded outgoing media message. The message management system transmits this notification of confirmation of the recorded outgoing media message being deleted to the sender device. On receiving the notification from the message management system, the client application on the sender device deletes the recorded outgoing media message from the sender device. In an embodiment, the message management system transmits a notification to the sender device indicating that the recorded outgoing media message is successfully withdrawn from the recipient devices.

Consider an example where a recipient Y receives a recorded outgoing media message from a sender X. Recipient Y forwards the recorded outgoing media message to another recipient Z. When the message management system receives a withdrawal indication from recipient Y, the message management system deletes the recorded outgoing media message from the recipient devices of recipient Y and recipient Z. As the message management system enables only a sender who sends a recorded outgoing media message, to withdraw the recorded outgoing media message from the recipient device, the message management system does not withdraw the recorded outgoing media message from the sender device of sender X. Consider another example where a sender X sends a recorded outgoing media message to a recipient Y. Recipient Y then forwards the recorded outgoing media message to another recipient Z. When the message management system receives a withdrawal indication from the sender device of sender X, the message management system withdraws the recorded outgoing media message from the sender device of sender X and the recipient devices of recipient Y and recipient Z.

Consider an example of managing an outgoing media message such as a voicemail message. For purposes of illustration, the detailed description refers to the outgoing media message being a voicemail message; however the scope of the method and system disclosed herein is not limited to the outgoing media message being a voicemail message, but may be extended to include, for example, a text message, a video message, an audiovisual message, a multimedia message, and other functionally equivalent types of outgoing media messages. A calling party attempts to call a called party via a network. A first network component associated with the calling party, receives the call attempt from the calling party to contact the called party. The first network component routes the received call attempt to a second network component associated with the called party, for establishing a communications link between the calling party and the called party. If the call attempt is unanswered on occurrence of one or more events comprising, for example, the called party being busy, the called party device being in an out of coverage area, the called party being unreachable, etc., the second network component redirects the unanswered call attempt to the message management system. The message management system receives the unanswered call attempt made by the calling party to the called party and redirected from the second network component. The calling party may record an outgoing voicemail message for the calling party to complete the unanswered call attempt. The message management system obtains the outgoing voicemail message recorded by the calling party, for example, from a third party voicemail system. The message management system provides access to the recorded outgoing voicemail message via multiple access modes, for example, a client application provided on the calling party device, a browser application accessible via the network, an access code for retrieving the recorded outgoing voicemail message, a voice call made to an interactive voice response (IVR) system to browse and listen to the recorded outgoing voicemail message, a link for retrieving the recorded outgoing voicemail message, etc., to the calling party over a network.

The message management system manages one or more of multiple actions performed on the recorded outgoing voicemail message. The actions performed on the recorded outgoing voicemail message comprise, for example, listening to the recorded outgoing voicemail message, viewing an envelope of the recorded outgoing voicemail message, listening to the envelope of the recorded outgoing voicemail message, editing the recorded outgoing voicemail message, deleting the recorded outgoing voicemail message, withdrawing the recorded outgoing voicemail message, marking a priority for the recorded outgoing voicemail message, forwarding the recorded outgoing voicemail message to one or more subsequent parties, sharing the recorded outgoing voicemail message on one or more social networking platforms, etc. The message management system manages a withdrawal action performed on the recorded outgoing voicemail message, on receiving a withdrawal indication from a sender of the recorded outgoing voicemail message. The message management system manages the withdrawal action by deleting the recorded outgoing voicemail message from a sender device of the sender of the recorded outgoing voicemail message and a recipient device of a recipient of the recorded outgoing voicemail message. For example, after the calling party sends a recorded outgoing voicemail message to the called party via the message management system, the calling party may wish to withdraw the recorded outgoing voicemail message. On receiving a withdrawal indication from the calling party who recorded the outgoing voicemail message for the called party, the message management system deletes the recorded outgoing voicemail message from the calling party device and the called party device.

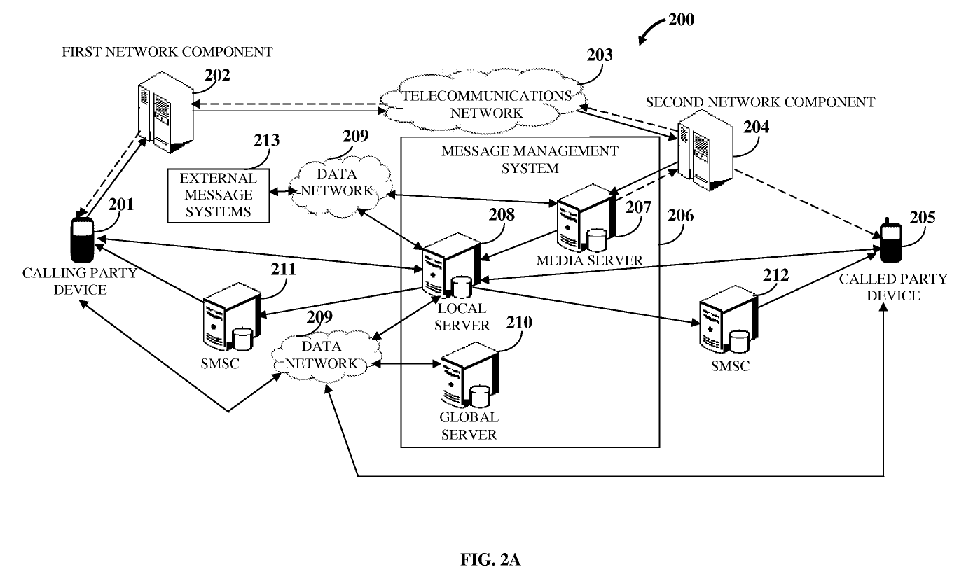

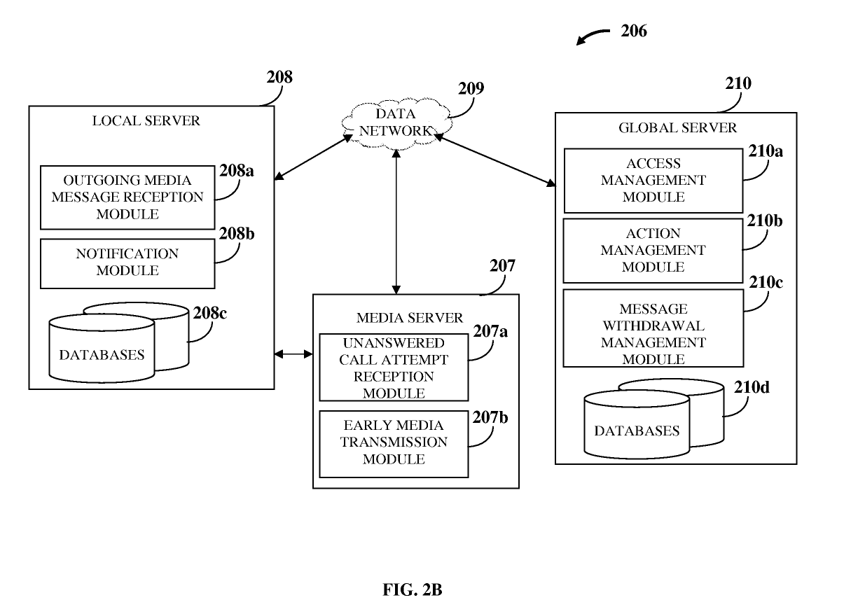

FIG. 2A exemplarily illustrates a computer implemented system 200 for managing outgoing media messages. The computer implemented system 200 disclosed herein comprises the message management system 206 in communication with a calling party device 201, a called party device 205, and their associated network components 202 and 204. The message management system 206 is accessible to the calling party device 201 and the called party device 205, for example, through a broad spectrum of technologies and devices such as personal computers with access to the internet, internet enabled cellular phones, tablet computing devices, etc. The first network component 202 is connected to the second network component 204 via a network, hereinafter referred to as a telecommunications network 203. The telecommunications network 203 is, for example, a wired telephony network, a wireless network, a voice call network, a signaling system number 7 (SS7) network, a mobile telecommunication network, a public telephone network, etc. In an embodiment, the message management system 206 is implemented as a system of one or more servers, for example, a media server 207, a local server 208, a global server 210, etc., that manage the outgoing media messages. The media server 207 of the message management system 206 is configured to enable call completion. In an embodiment, the media server 207 is configured, for example, as a voice platform or a voicemail server that transmits early media notifications to the calling party device 201 via the telecommunications network 203. In an embodiment, the media server 207 configured as a voice platform executes entire functions for managing the recorded outgoing media messages.

The local server 208 of the message management system 206 communicates with the global server 210 via a network, hereinafter referred to as a data network 209. The data network 209 is, for example, the internet, an intranet, a wired network, a wireless network, a network that implements Wi-Fi® of Wi-Fi Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks, etc. The local server 208 also communicates with short message service centers (SMSCs) 211 and 212 associated with the calling party device 201 and the called party device 205 respectively.

The global server 210 of the message management system 206 is deployed, for example, in carrier networks and in a cloud computing environment. As used herein, “cloud computing environment” refers to a processing environment comprising configurable computing physical and logical resources, for example, networks, servers, storage, applications, services, etc., and data distributed over the data network 209. The cloud computing environment provides on-demand network access to a shared pool of the configurable computing physical and logical resources. In an embodiment, the message management system 206 is a cloud computing based platform implemented as a service for managing outgoing media messages. The message management system 206 is developed, for example, using the Google App engine cloud infrastructure of Google Inc. In an embodiment, multiple platforms are used to implement the message management system 206. The platforms comprise, for example, a cloud computing based platform, a web services based platform, etc. The message management system 206 is deployed in multiple configurations, for example, in a data center of a network carrier, in a cloud infrastructure such as Amazon Web Services® of Amazon Technologies, Inc., Amazon elastic compute cloud EC2® of Amazon Technologies, Inc., Google® Cloud of Google Inc., Microsoft® Cloud of Microsoft Corporation, etc., in a data center implemented by the message management system 206, in a data center hosted by a third party system, etc.

The global server 210 is integrated with push notification services from cloud network notification services, for example, Google® Cloud Messaging (GCM) of Google Inc., the Apple Push Notification service (APNS) of Apple Inc., the Windows® Push Notification Services (WNS) of Microsoft Corporation, the Nokia® Notifications Service of Nokia Corporation, the Blackberry® Push Service of BlackBerry Limited, etherSMS® of etherSMS, LLC, OpenPush, etc. The local server 208 is deployed, for example, in carrier networks and in the cloud computing environment. Each of the global server 210 and the local server 208 comprises an application server (not shown) and a database server (not shown). The application server manages creation and routing of outgoing media messages from the local server 208 to the global server 210 and vice versa, sending notifications to the sender and/or the recipient of a new outgoing media message, executing actions on outgoing media messages such as converting the outgoing media messages from one format to another format, forwarding an outgoing media message to another user, deleting an outgoing media message, withdrawing an outgoing media message, etc. The global server 210 also manages access of client applications and browser applications to the recorded outgoing media messages. The application server serves as middleware between an end user client application and the database server. The database server manages databases that store the recorded outgoing media messages.

The global server 210 and the local server 208 deployed in the carrier networks are integrated with mobile switching centers (MSCs), for example, the first network component 202 associated with the calling party device 201 and the second network component 204 associated with the called party device 205, a signal transfer point (STP) (not shown), the SMSCs 211 and 212, and an intelligent network (IN) charging server (not shown). The global server 210 and the local server 208 deployed in the cloud computing environment are integrated with local points of presence in different countries and with SMSC aggregators. When the message management system 206 does not have a platform in a carrier's network, the local points of presence facilitate routing of voice calls that the calling party makes using this carrier's network to the message management system 206. The SMSC aggregators deliver the recorded outgoing media message, for example, via a short message service (SMS), when the carrier's SMSC, for example, 212 is not available to deliver the recorded outgoing media message to the called party device 205.

Consider an example where a calling party A using the calling party device 201 attempts to call the called party device 205 of a called party B. The first network component 202, for example, the originating mobile switching center (MSC) associated with the calling party device 201 receives the call attempt to contact called party B from the calling party device 201. The first network component 202 routes the received call attempt to the second network component 204, for example, the terminating MSC, associated with called party B for establishing a communications link between the calling party device 201 and the called party device 205, over the telecommunications network 203. The second network component 204 routes the call to the called party device 205, which results in an unanswered or incomplete call attempt, for example, due to called party B being busy, the called party device 205 being in an out of coverage area, the called party device 205 being switched off, etc. The second network component 204 then redirects the unanswered call attempt to a fixed C number associated with the media server 207 and routes the unanswered call attempt to the media server 207. In this example, the media server 207 is, for example, a voice platform that operably communicates with the local server 208.

In an embodiment, the media server 207 of the message management system 206 plays an early media notification in one or more media modes to the calling party device 201 for a predefined time period. In an embodiment, the media server 207 provides an option to calling party A via the early media notification to stay on the line for recording an outgoing media message at applicable voice calling rates to complete the unanswered call attempt. If calling party A does not hang up before the predefined time period, the call is answered and calling party A records an outgoing media message, for example, a voicemail message or a video message on the local server 208. In an embodiment, the message management system 206 obtains the recorded outgoing media message after transmitting the early media notification. In another embodiment, the message management system 206 obtains the recorded outgoing media message without transmitting an early media notification. In an embodiment, the message management system 206 integrates with one or more external message systems 213 configured to store the recorded outgoing media message. The message management system 206 communicates with one or more external message systems 213 via the data network 209 for obtaining the recorded outgoing media message and managing one or more actions performed on the recorded outgoing media message. The local server 208 of the message management system 206 receives the recorded outgoing media message and forwards the recorded outgoing media message to the global server 210 over the data network 209. The global server 210 sends the recorded outgoing media message to the called party device 205 and the calling party device 201 over the data network 209, provided the called party device 205 and the calling party device 201 have connectivity to the data network 209.

If the calling party device 201 has a smart phone client application associated with the message management system 206, then the recorded outgoing media message can be listened to or viewed by calling party A via the client application. Calling party A can also access the recorded outgoing media message using a browser via a web link leading, for example, to a message management application. On accessing the recorded outgoing media message, calling party A can perform multiple actions, for example, delete the recorded outgoing media message, withdraw the recorded outgoing media message, send another media message to called party B, forward the recorded outgoing media message to another phone number, share the recorded outgoing media message on a social networking platform such as Facebook®, Twitter®, etc.

If the calling party device 201 does not have connectivity to the data network 209 or is temporarily out of a connectivity range of the data network 209, then the local server 208 sends notifications via the SMSC 211 to the calling party device 201. This notification comprises, for example, a retrieval number or code, a retrieval link, etc., sent in one or more modes, for example, a short message service (SMS), an electronic mail (email), etc., to calling party A. On receiving the notification, calling party A can access the recorded outgoing media message by calling the retrieval number or by saving the retrieval link until the calling party device 201 obtains access to the data network 209. If the called party device 205 does not have connectivity to the data network 209 or is temporarily out of a connectivity range of the data network 209, then the local server 208 sends notifications comprising, for example, a retrieval number or code, a retrieval link, etc., via the SMSC 212 to the called party device 205 to enable called party B to access and retrieve the recorded outgoing media message.

The method and the computer implemented system 200 disclosed herein therefore allows calling party A to access the recorded outgoing media message through multiple access modes, for example, by accessing the recorded outgoing media message from a client application running, for example, on a smart phone or a tablet device, accessing the recorded outgoing media message by calling a short retrieval code or a retrieval number, or accessing the recorded outgoing media message by clicking on a link from a data enabled phone or a tablet device. On accessing the recorded outgoing media message, calling party A can perform one or more of multiple actions on the recorded outgoing media message. Calling party A can, for example, listen to the recorded outgoing media message, listen to the envelope of the recorded outgoing media message, mark a priority for the recorded outgoing media message, delete the recorded outgoing media message, withdraw the recorded outgoing media message, edit the recorded outgoing media message, forward the recorded outgoing media message to another user identified by a phone number, forward the recorded outgoing media message to another user identified by an email address, forward the recorded outgoing media message to another user through an address book entry on the calling party device 201, or on a subscriber identity module (SIM), or on a cloud service of Google Inc., Apple Inc., or Outlook® of Microsoft Corporation, forward the recorded outgoing media message to a Facebook® friend, forward the recorded outgoing media message to a Twitter® follower, forward the recorded outgoing media message to a group of users, share the recorded outgoing media message on social networking platforms such as Facebook®, Twitter®, Google+® of Google Inc., LinkedIn®, etc.

FIG. 2B exemplarily illustrates an implementation of the message management system 206 for managing outgoing media messages. In the implementation exemplarily illustrated in FIG. 2B, the message management system 206 comprises the local server 208 and the global server 210 that communicate with each other via the data network 209. In an embodiment, the message management system 206 further comprises the media server 207 operably connected to the local server 208. The media server 207 communicates with the local server 208 directly or, in an embodiment, via the data network 209. The media server 207, the local server 208, and the global server 210, each comprise a non-transitory computer readable storage medium that stores respective modules 207a, 207b, 208a, 208b, and 210a, 210b, and 210c of the message management system 206 as exemplarily illustrated in FIG. 2B. As used herein, “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The media server 207, the local server 208, and the global server 210, each further comprise at least one processor communicatively coupled to the non-transitory computer readable storage medium for executing the respectively stored modules 207a, 207b, 208a, 208b, and 210a, 210b, and 210c of the message management system 206.

As exemplarily illustrated in FIG. 2B, the media server 207 comprises an unanswered call attempt reception module 207a and an early media transmission module 207b. The unanswered call attempt reception module 207a receives an unanswered call attempt made by the calling party using the calling party device 201 to the called party device 205 of the called party and redirected from a network component, for example, the second network component 204 exemplarily illustrated in FIG. 2A. On detection of the unanswered call attempt, in an embodiment, the early media transmission module 207b transmits an early media notification in one or more of multiple media modes, for example, an audio mode, a video mode, etc., to the calling party device 201 for a predefined time period. As exemplarily illustrated in FIG. 2B, the local server 208 comprises an outgoing media message reception module 208a, a notification module 208b, and one or more databases 208c. The outgoing media message reception module 208a obtains the outgoing media message recorded by the calling party to complete the unanswered call attempt, and stores the recorded outgoing media message in one or more of the databases 208c. In an embodiment, the outgoing media message reception module 208a communicates with one or more external message systems 213 exemplarily illustrated in FIG. 2A, for obtaining the recorded outgoing media message. The outgoing media message reception module 208a also transmits the recorded outgoing media message to the global server 210 via the data network 209.

The global server 210 comprises an access management module 210a, an action management module 210b, a message withdrawal management module 210c, and one or more databases 210d. The databases 210d store the recorded outgoing media message received from the local server 208. The access management module 210a provides access to the recorded outgoing media message via multiple access modes, for example, a client application, a browser application accessible via the data network 209, etc., to the calling party over the data network 209. The recorded outgoing media message can be accessed via multiple browsers, for example, Internet Explorer® (IE) 7, IE 8, and IE 9 of Microsoft Corporation, Mozilla® Firefox® of Mozilla Foundation, Safari® of Apple Inc., Chrome of Google, Inc., etc., and is compatible with technologies, for example, hypertext markup language 5 (HTML5), etc. The action management module 210b manages one or more of multiple actions, for example, forwarding the recorded outgoing media message, sharing the recorded outgoing media message on one or more social networking platforms, etc., performed on the recorded outgoing media message. In an embodiment, the action management module 210b schedules one or more of the actions performed on the recorded outgoing media message.

The message withdrawal management module 210c of the global server 210 manages a withdrawal action performed on the recorded outgoing media message, on receiving a withdrawal indication from a sender, for example, a calling party, a called party, and/or one or more subsequent parties of the recorded outgoing media message. Client applications (not shown) of the sender device, for example, the calling party device 201, and the recipient device, for example, the called party device 205 communicate with the message withdrawal management module 210c of the global server 210 that executes withdrawal action functions of the message management system 206. In an embodiment, the message withdrawal management module 210c deletes the recorded outgoing media message from a sender device of the sender, for example, the calling party, of the recorded outgoing media message and from a recipient device of a recipient, for example, a called party and/or one or more subsequent parties, of the recorded outgoing media message.

In an embodiment, in the absence of data connectivity, the notification module 208b of the local server 208 transmits a message notification comprising a message retrieval code or a message retrieval link, to the calling party device 201 via the short message service center (SMSC) 211 exemplarily illustrated in FIG. 2A, for enabling the calling party to retrieve the recorded outgoing media message from the databases 208c or 210d. The databases 208c and 210d can be any storage area or medium that can be used for storing data and files. The databases 208c and 210d are each configured, for example, as a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j™ graph database of Neo Technology Corporation., the Cassandra database of the Apache Software Foundation, the HBase™ database of the Apache Software Foundation, etc. In an embodiment, the databases 208c and 210d can also be locations on respective file systems. In another embodiment, the databases 208c and 210d can be remotely accessed by the local server 208 and the global server 210 of the message management system 206 respectively, via the data network 209. In another embodiment, the databases 208c and 210d are configured as cloud based databases implemented in the cloud computing environment, where computing resources are delivered as a service over the data network 209.

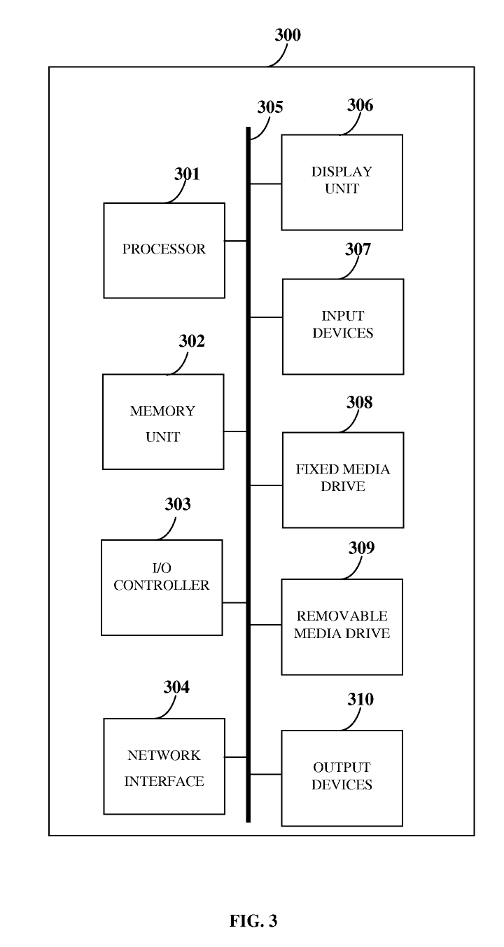

FIG. 3 exemplarily illustrates the architecture of a computer system 300 employed by the message management system 206, exemplarily illustrated in FIGS. 2A-2B, for managing outgoing media messages. The media server 207, the local server 208 and the global server 210 of the message management system 206 exemplarily illustrated in FIGS. 2A-2B, each employs the architecture of the computer system 300 exemplarily illustrated in FIG. 3. The computer system 300 is programmable using a high level computer programming language. The computer system 300 may be implemented using programmed and purposeful hardware.

The message management system 206 communicates with the calling party device 201 and the called party device 205, for example, via the data network 209 as exemplarily illustrated in FIG. 2A. The telecommunications network 203 that connects the first network component 202 and the second network component 204 exemplarily illustrated in FIG. 2A, and the data network 209 are, for example, short range or long range networks, mobile telecommunication carriers' networks, etc. The computer system 300 comprises, for example, a processor 301, a non-transitory computer readable storage medium such as a memory unit 302 for storing programs and data, an input/output (I/O) controller 303, a network interface 304, a data bus 305, a display unit 306, input devices 307, a fixed media drive 308 such as a hard drive, a removable media drive 309 for receiving removable media, output devices 310, etc.

The processor 301 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 301 may also be implemented as a processor set comprising, for example, a general purpose microprocessor and a math or graphics co-processor. The processor 301 is selected, for example, from the Intel® processors such as the Itanium® microprocessor or the Pentium® processors, Advanced Micro Devices (AMD®) processors such as the Athlon® processor, UltraSPARC® processors, microSPARC™ processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The message management system 206 disclosed herein is not limited to a computer system 300 employing a processor 301. The computer system 300 may also employ a controller or a microcontroller. The processor 301 executes respective modules, for example, 207a, 207b, 208a, 208b, and 210a, 210b, 210c of the message management system 206.

The memory unit 302 is used for storing programs, applications, and data. For example, the unanswered call attempt reception module 207a and the early media transmission module 207b are stored in the memory unit 302 of the media server 207. The outgoing media message reception module 208a and the notification module 208b are stored in the memory unit 302 of the local server 208. The access management module 210a, the action management module 210b, and the message withdrawal management module 210c are stored in the memory unit 302 of the global server 210. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301. The I/O controller 303 controls input actions and output actions performed by the message management system 206.

The network interface 304 enables connection of the computer system 300 to the data network 209. For example, the media server 207, the local server 208 and the global server 210, each connects to the data network 209 via the network interface 304. In an embodiment, the network interface 304 is provided as an interface card also referred to as a line card. The network interface 304 comprises, for example, one or more of an infrared (IR) interface, an interface implementing Wi-Fi®, a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The data bus 305 permits communications between the modules, for example, 207a and 207b of the media server 207, between the modules, for example, 208a, 208b, and 208c of the local server 208, and between the modules, for example, 210a, 210b, 210c, and 210d of the global server 210.

The display unit 306 displays information, display interfaces, user interface elements such as text fields, checkboxes, text boxes, windows, edit options, share options, forward options, etc., for allowing administrators of the message management system 206 to manage multiple actions performed on the outgoing media messages by the calling party and the called party. The display unit 306 comprises, for example, a liquid crystal display, a plasma display, an organic light emitting diode (OLED) based display, etc. The input devices 307 are used for inputting data into the computer system 300. The input devices 307 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly via the data network 209. Computer applications and programs are executed by double clicking a related icon displayed on the display unit 306 using one of the input devices 307. The output devices 310 output the results of operations performed by the message management system 206. For example, the message management system 206 provides access to the outgoing media messages and provides a customized list of outgoing media messages received, for example, by an administrator, using the output devices 310. The message management system 206 displays the outgoing media messages using the output devices 310.

The processor 301 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., the Palm OS®, the Solaris operating system developed by Sun Microsystems, Inc., the Android operating system, the Windows Phone® operating system of Microsoft Corporation, the BlackBerry® operating system of BlackBerry Limited, the iOS operating system of Apple Inc., the Symbian® operating system of Symbian Foundation Limited, etc. The computer system 300 employs the operating system for performing multiple tasks. The operating system is responsible for management and coordination of activities and sharing of resources of the computer system 300. The operating system further manages security of the computer system 300, peripheral devices connected to the computer system 300, and network connections. The operating system employed on the computer system 300 recognizes, for example, inputs provided by users using one of the input devices 307, the output display, files, and directories stored locally on the fixed media drive 308. The operating system on the computer system 300 executes different programs using the processor 301. The processor 301 and the operating system together define a computer platform for which application programs in high level programming languages are written.

Each processor 301 of the message management system 206 retrieves instructions for executing the respective modules, for example, 207a, 207b, 208a, 208b, 210a, 210b, 210c, etc., of the message management system 206 from each associated memory unit 302. A program counter determines the location of the instructions in the memory unit 302. The program counter stores a number that identifies the current position in the program of each of the modules, for example, 207a, 207b, 208a, 208b, 210a, 210b, 210c, etc., of the message management system 206. The instructions fetched by the processor 301 from the memory unit 302 after being processed are decoded. The instructions are stored in an instruction register in the processor 301. After processing and decoding, the processor 301 executes the instructions.

The processor 301 of the computer system 300 employed by the media server 207 retrieves the instructions defined by the unanswered call attempt reception module 207a and the early media transmission module 207b of the media server 207 for performing respective functions disclosed in the detailed description of FIG. 2B. The processor 301 of the computer system 300 employed by the local server 208 retrieves the instructions defined by the outgoing media message reception module 208a and the notification module 208b of the local server 208 for performing respective functions disclosed in the detailed description of FIG. 2B. The processor 301 of the computer system 300 employed by the global server 210 retrieves the instructions defined by the access management module 210a, the action management module 210b, and the message withdrawal management module 210c of the global server 210 for performing respective functions disclosed in the detailed description of FIG. 2B.

At the time of execution, the instructions stored in the instruction register are examined to determine the operations to be performed. The processor 301 then performs the specified operations. The operations comprise arithmetic operations and logic operations. The operating system performs multiple routines for performing a number of tasks required to assign the input devices 307, the output devices 310, and memory for execution of respective modules, for example, 207a, 207b, 208a, 208b, 210a, 210b, 210c, etc., of the message management system 206. The tasks performed by the operating system comprise, for example, assigning memory to the respective modules, for example, 207a, 207b, 208a, 208b, 210a, 210b, 210c, etc., of the message management system 206, and to data used by the message management system 206, moving data between the memory unit 302 and disk units, and handling input/output operations. The operating system performs the tasks on request by the operations and after performing the tasks, the operating system transfers the execution control back to the processor 301. The processor 301 continues the execution to obtain one or more outputs. The outputs of the execution of the modules, for example, 207a, 207b, 208a, 208b, 210a, 210b, 210c, etc., of the message management system 206 are displayed to the user on the display unit 306.

For purposes of illustration, the detailed description refers to the media server 207, the local server 208 and the global server 210, each being run locally on the computer system 300; however the scope of the method and computer implemented system 200 disclosed herein is not limited to the media server 207, the local server 208 and the global server 210, each being run locally on the computer system 300 via the operating system and the processor 301, but may be extended to be run remotely over the data network 209 by employing a web browser and a remote server, a mobile phone, or other electronic devices. One or more portions of the computer system 300 may be distributed across one or more computer systems (not shown) coupled to the data network 209.

Disclosed herein is also a computer program product comprising a non-transitory computer readable storage medium that stores computer program codes comprising instructions executable by at least one processor 301 for managing outgoing media messages. The computer program product disclosed herein comprises a first computer program code for obtaining an outgoing media message recorded by a calling party to complete an unanswered call attempt made by the calling party to a called party; a second computer program code for providing access to the recorded outgoing media message via multiple access modes to the calling party over the data network 209; and a third computer program code for managing one or more of multiple actions performed on the recorded outgoing media message. The computer program product disclosed herein further comprises a fourth computer program code for transmitting an early media notification in one or more of multiple media modes to the calling party device 201 for a predefined time period, for example, on occurrence of one or more of multiple events. The computer program product disclosed herein further comprises a fifth computer program code for managing a withdrawal action performed on the recorded outgoing media message on receiving a withdrawal indication from a sender of the recorded outgoing media message. The fifth computer program code comprises a sixth computer program code for deleting the recorded outgoing media message from a sender device of the sender of the recorded outgoing media message and from a recipient device of a recipient of the recorded outgoing media message. The computer program product disclosed herein further comprises one or more additional computer program codes for performing additional steps that may be required and contemplated for managing outgoing media messages. In an embodiment, a single piece of computer program code comprising computer executable instructions performs one or more steps of the computer implemented method disclosed herein for managing outgoing media messages.

The computer program codes comprising computer executable instructions are embodied on the non-transitory computer readable storage medium. The processor 301 of the computer system 300 retrieves these computer executable instructions and executes them. When the computer executable instructions are executed by the processor 301, the computer executable instructions cause the processor 301 to perform the steps of the computer implemented method for managing outgoing media messages.

It will be readily apparent that the various methods, algorithms, and computer programs disclosed herein may be implemented on computer readable media appropriately programmed for computing devices. As used herein, “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, JavaScript®, Fortran, Ruby, Perl®, Python®, Visual Basic®, hypertext preprocessor (PHP), Microsoft® .NET etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises one or more computer program codes for implementing the processes of various embodiments.

Where databases are described such as the databases 208c and 210d, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A method for managing outgoing media messages, said method employing a message management system comprising at least one processor configured to execute computer program instructions for performing said method, said method comprising:
receiving, by said message management system, an unanswered call attempt made by a calling party to a called party and redirected from a network component;
obtaining, by said message management system, an outgoing media message recorded by said calling party to complete said unanswered call attempt;
providing access to said recorded outgoing media message via a plurality of access modes by said message management system to said calling party over a network; and
managing one or more of a plurality of actions performed on said recorded outgoing media message by said message management system.

2. The method of claim 1, wherein said outgoing media message is selected from the group consisting of a voicemail message, an audio message, a video message, an audiovisual message, a multimedia message, a text message, and combinations thereof.

3. The method of claim 1, wherein said access modes comprise access via one of a client application provided on a calling party device, a browser application accessible via said network, an access code for retrieving said recorded outgoing media message, a voice call made to an interactive voice response system to browse and listen to said recorded outgoing media message, and a link for retrieving said recorded outgoing media message.

4. The method of claim 1, wherein said actions performed on said recorded outgoing media message comprise viewing said recorded outgoing media message, listening to said recorded outgoing media message, viewing an envelope of said recorded outgoing media message, listening to said envelope of said recorded outgoing media message, editing said recorded outgoing media message, deleting said recorded outgoing media message, withdrawing said recorded outgoing media message, marking a priority for said recorded outgoing media message, forwarding said recorded outgoing media message to one or more subsequent parties, and sharing said recorded outgoing media message on one or more social networking platforms.

5. The method of claim 1, further comprising scheduling said one or more of said actions performed on said recorded outgoing media message by said message management system.

6. The method of claim 1, further comprising managing a withdrawal action performed on said recorded outgoing media message, by said message management system on receiving a withdrawal indication from a sender of said recorded outgoing media message, wherein said sender is selected from the group consisting of said calling party, said called party, and one or more subsequent parties, and wherein said management of said withdrawal action by said message management system comprises deleting said recorded outgoing media message from a sender device of said sender of said recorded outgoing media message and a recipient device of a recipient of said recorded outgoing media message, and wherein said recipient is selected from the group consisting of said called party and said one or more subsequent parties.

7. The method of claim 1, further comprising transmitting an early media notification in one or more of a plurality of media modes to said calling party by said message management system for a predefined time period, wherein said early media notification is configured to provide one or more options to said calling party to record said outgoing media message.

8. The method of claim 7, wherein said media modes of said early media notification are selected from the group consisting of a text mode, an image mode, an audio mode, a video mode, an audiovisual mode, a multimedia mode, and combinations thereof.

9. The method of claim 1, wherein said message management system is configured as one of a downloadable software application executable by said at least one processor on a calling party device and a called party device over said network, a web based platform, a networked system, and combinations thereof.

10. The method of claim 1, further comprising communicating with one or more external message systems configured to store said recorded outgoing media message by said message management system for said obtaining of said recorded outgoing media message and for said management of said one or more of said actions performed on said recorded outgoing media message.

11. The method of claim 1, wherein said redirection of said unanswered call attempt by said network component comprises:
receiving a call attempt from said calling party to contact said called party by a first network component associated with said calling party;
routing said received call attempt by said first network component to a second network component associated with said called party for establishing a communications link between said calling party and said called party; and
redirecting said unanswered call attempt to said message management system by said second network component on occurrence of one or more of a plurality of events.

12. The method of claim 11, wherein said events for said redirection of said unanswered call attempt to said message management system by said second network component are selected from the group consisting of said called party being busy, said called party being in an out of coverage area, said called party being unreachable, a called party device being switched off, network congestion, and said call attempt not being answered by said called party.

13. A method for managing outgoing voicemail messages, said method employing a message management system comprising at least one processor configured to execute computer program instructions for performing said method, said method comprising:
receiving, by said message management system, an unanswered call attempt made by a calling party to a called party and redirected from a network component;
obtaining, by said message management system, an outgoing voicemail message recorded by said calling party to complete said unanswered call attempt;
providing access to said recorded outgoing voicemail message via a plurality of access modes by said message management system to said calling party over a network; and
managing one or more of a plurality of actions performed on said recorded outgoing voicemail message by said message management system.

14. The method of claim 13, wherein said access modes comprise access via one of a client application provided on a calling party device, a browser application accessible via said network, an access code for retrieving said recorded outgoing voicemail message, a voice call made to an interactive voice response system to browse and listen to said recorded outgoing voicemail message, and a link for retrieving said recorded outgoing voicemail message.

15. The method of claim 13, wherein said actions performed on said recorded outgoing voicemail message comprise listening to said recorded outgoing voicemail message, viewing an envelope of said recorded outgoing voicemail message, listening to said envelope of said recorded outgoing voicemail message, editing said recorded outgoing voicemail message, deleting said recorded outgoing voicemail message, withdrawing said recorded outgoing voicemail message, marking a priority for said recorded outgoing voicemail message, forwarding said recorded outgoing voicemail message to one or more subsequent parties, and sharing said recorded outgoing voicemail message on one or more social networking platforms.

16. The method of claim 13, further comprising scheduling said one or more of said actions performed on said recorded outgoing voicemail message by said message management system.

17. The method of claim 13, further comprising managing a withdrawal action performed on said recorded outgoing voicemail message, by said message management system on receiving a withdrawal indication from a sender of said recorded outgoing voicemail message, wherein said sender is selected from the group consisting of said calling party, said called party, and one or more subsequent parties, and wherein said management of said withdrawal action by said message management system comprises deleting said recorded outgoing voicemail message from a sender device of said sender of said recorded outgoing voicemail message and a recipient device of a recipient of said recorded outgoing voicemail message, and wherein said recipient is selected from the group consisting of said called party and said one or more subsequent parties.

18. The method of claim 13, further comprising transmitting an early media notification in one or more of a plurality of media modes to said calling party by said message management system for a predefined time period, wherein said early media notification is configured to provide one or more options to said calling party to record said outgoing voicemail message.

19. The method of claim 18, wherein said media modes of said early media notification are selected from the group consisting of a text mode, an image mode, an audio mode, a video mode, an audiovisual mode, a multimedia mode, and combinations thereof.

20. The method of claim 13, wherein said message management system is configured as one of a downloadable software application executable by said at least one processor on a calling party device and a called party device over said network, a web based platform, a networked system, and combinations thereof.

21. The method of claim 13, further comprising communicating with one or more external message management systems configured to store said recorded outgoing voicemail message by said message management system for said obtaining of said recorded outgoing voicemail message and for said management of said one or more of said actions performed on said recorded outgoing voicemail message.

22. The method of claim 13, wherein said redirection of said unanswered call attempt by said network component comprises:
receiving a call attempt from said calling party to contact said called party by a first network component associated with said calling party;
routing said received call attempt by said first network component to a second network component associated with said called party for establishing a communications link between said calling party and said called party; and
redirecting said unanswered call attempt to said message management system by said second network component on occurrence of one or more of a plurality of events.

23. The method of claim 22, wherein said events for said redirection of said unanswered call attempt to said message management system by said second network component are selected from the group consisting of said called party being busy, said called party being in an out of coverage area, said called party being unreachable, a called party device being switched off, network congestion, and said call attempt not being answered by said called party.

24. A message management system for managing outgoing media messages, said message management system comprising:
a non-transitory computer readable storage medium configured to store modules of said message management system;
at least one processor communicatively coupled to said non-transitory computer readable storage medium, said at least one processor configured to execute said modules of said message management system; and
said modules of said message management system comprising:
an unanswered call attempt reception module configured to receive an unanswered call attempt made by a calling party to a called party and redirected from a network component;
an outgoing media message reception module configured to obtain an outgoing media message recorded by said calling party to complete said unanswered call attempt;
an access management module configured to provide access to said recorded outgoing media message via a plurality of access modes to said calling party over a network; and
an action management module configured to manage one or more of a plurality of actions performed on said recorded outgoing media message.

25. The message management system of claim 24, wherein said outgoing media message is selected from the group consisting of a voicemail message, an audio message, a video message, an audiovisual message, a multimedia message, a text message, and combinations thereof.

26. The message management system of claim 24, wherein said access modes comprise access via one of a client application provided on a calling party device, a browser application accessible via said network, an access code for retrieving said recorded outgoing media message, a voice call made to an interactive voice response system to browse and listen to said recorded outgoing media message, and a link for retrieving said recorded outgoing media message.

27. The message management system of claim 24, wherein said actions performed on said recorded outgoing media message comprise viewing said recorded outgoing media message, listening to said recorded outgoing media message, viewing an envelope of said recorded outgoing media message, listening to said envelope of said recorded outgoing media message, editing said recorded outgoing media message, deleting said recorded outgoing media message, withdrawing said recorded outgoing media message, marking a priority for said recorded outgoing media message, forwarding said recorded outgoing media message to one or more subsequent parties, and sharing said recorded outgoing media message on one or more social networking platforms.

28. The message management system of claim 24, wherein said action management module is further configured to schedule said one or more of said actions performed on said recorded outgoing media message.

29. The message management system of claim 24, further comprising a message withdrawal management module configured to manage a withdrawal action performed on said recorded outgoing media message, on receiving a withdrawal indication from a sender of said recorded outgoing media message, wherein said sender is selected from the group consisting of said calling party, said called party, and one or more subsequent parties, and wherein said message withdrawal management module is further configured to delete said recorded outgoing media message from a sender device of said sender of said recorded outgoing media message and a recipient device of a recipient of said recorded outgoing media message, and wherein said recipient is selected from the group consisting of said called party and said one or more subsequent parties.

30. The message management system of claim 24, further comprising an early media transmission module configured to transmit an early media notification in one or more of a plurality of media modes to said calling party for a predefined time period, wherein said early media notification is configured to provide one or more options to said calling party to record said outgoing media message.

31. The message management system of claim 30, wherein said media modes of said early media notification are selected from the group consisting of a text mode, an image mode, an audio mode, a video mode, an audiovisual mode, a multimedia mode, and combinations thereof.

32. The message management system of claim 24 configured as one of a downloadable software application executable by said at least one processor on a calling party device and a called party device over said network, a web based platform, a networked system, and combinations thereof.

33. The message management system of claim 24 implemented as a system of one or more servers configured to manage said outgoing media messages.

34. The message management system of claim 24, wherein said outgoing media message reception module is further configured to communicate with one or more external message systems configured to store said recorded outgoing media message, for said obtaining of said recorded outgoing media message.

35. The message management system of claim 24, wherein said network component is configured to redirect said unanswered call attempt to said message management system on occurrence of one or more of a plurality of events.

36. The message management system of claim 35, wherein said events for said redirection of said unanswered call attempt to said message management system by said network component are selected from the group consisting of said called party being busy, said called party being in an out of coverage area, said called party being unreachable, a called party device being switched off, network congestion, and said call attempt not being answered by said called party.

37. A computer program product comprising a non-transitory computer readable storage medium, said non-transitory computer readable storage medium storing computer program codes that comprise instructions executable by at least one processor, said computer program codes comprising:
a first computer program code for obtaining an outgoing media message recorded by a calling party to complete an unanswered call attempt made by said calling party to a called party;
a second computer program code for providing access to said recorded outgoing media message via a plurality of access modes to said calling party over a network, wherein said access modes comprise access via one of a client application provided on a calling party device, a browser application accessible via said network, an access code for retrieving said recorded outgoing media message, a voice call made to an interactive voice response system to browse and listen to said recorded outgoing media message, and a link for retrieving said recorded outgoing media message; and
a third computer program code for managing one or more of a plurality of actions performed on said recorded outgoing media message, wherein said actions performed on said recorded outgoing media message comprise viewing said recorded outgoing media message, listening to said recorded outgoing media message, viewing an envelope of said recorded outgoing media message, listening to said envelope of said recorded outgoing media message, editing said recorded outgoing media message, deleting said recorded outgoing media message, withdrawing said recorded outgoing media message, marking a priority for said recorded outgoing media message, forwarding said recorded outgoing media message to one or more parties, and sharing said recorded outgoing media message on one or more social networking platforms.

38. The computer program product of claim 37, further comprising a fourth computer program code for transmitting an early media notification in one or more of a plurality of media modes to said calling party for a predefined time period, wherein said early media notification is configured to provide one or more options to said calling party to record said outgoing media message, and wherein said media modes of said early media notification are selected from the group consisting of a text mode, an image mode, an audio mode, a video mode, an audiovisual mode, a multimedia mode, and combinations thereof.

39. The computer program product of claim 37, further comprising a fifth computer program code for managing a withdrawal action performed on said recorded outgoing media message on receiving a withdrawal indication from a sender of said recorded outgoing media message, wherein said sender is selected from the group consisting of said calling party, said called party, and one or more subsequent parties, and wherein said fifth computer program code comprises a sixth computer program code for deleting said recorded outgoing media message from a sender device of said sender of said recorded outgoing media message and a recipient device of a recipient of said recorded outgoing media message, and wherein said recipient is selected from the group consisting of said called party and said one or more subsequent parties.
